(19) United States
(12) Patent Application Publication
(10) Pub. No.: US 2010/0304042 A1
(43) Pub. Date: Dec. 2, 2010

(54) METHOD FOR FORMING SUPERHIGH STRESS LAYER

(76) Inventors: Hsiu-Lien Liao, Tai-Chung City (TW); Teng-Chun Tsai, Tainan City (TW); Jei-Ming Chen, Tainan City (TW); Yu-Tuan Tsai, Kaohsiung City (TW); Chien-Chung Huang, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 12/475,595

(22) Filed: May 31, 2009

(51) Int. Cl. B05D 3/14

(52) U.S. Cl. 427/551

(57) ABSTRACT

A method for forming super high stress layer is provided. First, a substrate is provided. Second, an ammonia-related pretreatment is performed on the substrate. The flow rate of ammonia is not less than s.c.c.m. and the high-frequency source power is set to be not less than 800 W. Later, the super high stress layer is formed on the substrate having undergone the ammonia-related pretreatment.

### BACKGROUND OF THE INVENTION

1. Field of the Invention

The present invention relates to a method for forming a super high stress layer. In particular, the present invention relates to a method for forming a super high stress layer in the absence of a high temperature process condition.

2. Description of the Prior Art

With the trend of miniaturization of semiconductor device dimensions, for example for the semiconductor processes with the critical dimension less than 65 nm, the scale of the gate, source and drain of a transistor decreases in accordance with the decrease in critical dimension (CD). Due to the physical limitation of the materials used, the decrease in scale of the gate, source and drain results in the decrease of carriers that determine the magnitude of the current in the transistor element, and this can therefore adversely affect the performance of the transistor. As a result, increasing carrier mobility in order to boost up a MOS transistor is an important topic in the field of current semiconductor techniques.

Among the current techniques, one of the most popular and well-known methods is to form a corresponding stress therein when a shallow trench isolation, a source, a drain, or a contact etch stop layer (CESL) is formed. For example, a compression stress is formed in order to modify the carrier mobility. Generally speaking, the greater the stress is, the higher gain for the carrier mobility is. Accordingly, persons of ordinary skills in the art all endeavor themselves in developing a processing method to pursue a greater stress gain.

For example, so far the published stress record of the best As-deposit for the PVCVD procedure is as low as −3.0 GPa. However, it is estimated that, for the process below 65 Å such as 45 Å process, 40 Å process or 32 Å process, the stress requirement for the compressive silicon nitride stress layer should be as low as −3.5 GPa. Accordingly, it is understood that the current PVCVD procedure fails to meet the demands of the compressive silicon nitride stress layer for the process below 65 Å.

Furthermore, if a silicide layer is formed before the compressive silicon nitride stress layer, NiSi in particular, is formed, the reaction temperature for the compressive silicon nitride stress layer should never exceed 400° C. or the silicide layer is destroyed. It is a concrete ceiling for people of ordinary skills in the art to pursue a greater stress gain.

### SUMMARY OF THE INVENTION

The present invention therefore proposes a method to form a stress layer with satisfying super high stress. The advantage of the present invention resides in the obtained compressive silicon nitride stress which is capable of providing a stress as low as −3.5 GPa under a reaction temperature less than 400° C. to meet the demands of the compressive silicon nitride stress layer for the process below 65 Å. On the other hand, the obtained compressive silicon nitride stress may provide a stress even less than −3.5 GPa under a reaction temperature high than 400° C.

The present invention in one aspect proposes a method for forming a super high stress layer. First, a substrate is provided. Second, an ammonia-related pretreatment is performed on the substrate The flow rate of ammonia is not less than 1000 s.c.c.m. and the high-frequency source power is set to be not less than 800 W. Later, the super high stress layer is formed on the substrate which has undergone the ammonia-related pretreatment.

The present invention in another aspect proposes a method for forming a super high stress layer. First, a substrate is provided. Second, a silicide procedure, such as nickel silicide, is performed on the substrate. Then an ammonia-related pretreatment is performed on the substrate under a temperature not greater than 400° C. The flow rate of ammonia is not less than 1000 s.c.c.m. and the high-frequency source power is set to be not less than 800 W. Later, the super high stress layer is formed on the substrate which has undergone the ammonia-related pretreatment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 illustrate a method for forming a super high stress layer of the present invention.

FIG. 3 illustrates a correlation between the pretreatment time and the compression stress in the super high stress layer of the method for forming a super high stress layer of the present invention.

FIG. 4 illustrates a correlation between the high-frequency source power and the compression stress in the super high stress layer of the method for forming a super high stress layer of the present invention.

FIG. 5 illustrates a correlation between the reaction temperature and the compression stress in the super high stress layer of the method for forming a super high stress layer of the present invention.

### DETAILED DESCRIPTION

The present invention provides a method to form a stress layer. The method of the present invention provides a compressive silicon nitride stress which is capable of providing a stress as low as −3.5 GPa under a reaction temperature not greater than 400° C. to meet the demands of the compressive silicon nitride stress layer for a process below 65 Å. On the other hand, the obtained compressive silicon nitride stress may provide a stress even less than −3.5 GPa under a reaction temperature high than 400° C.

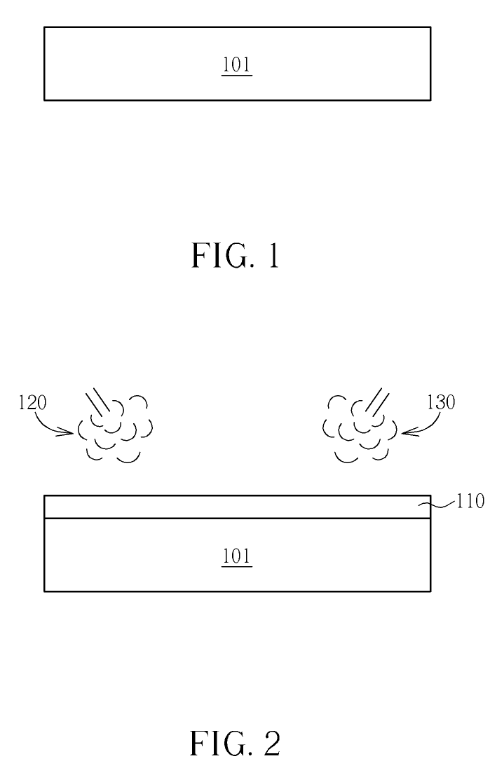

Please refer to FIGS. 1-2, illustrating a method for forming a super high stress layer of the present invention. First, as shown in FIG. 1, a substrate 101 is provided. The substrate 101 may have undergone suitable semiconductor processes to form various semiconductor elements (not shown), such as NMOS, PMOS, doping regions, gates, shallow trench isolations or strained channels and material layers (not shown) such as gate isolation layers, sidewalls or silicide. Preferably, the silicide is not a nickel one.

Afterwards, an ammonia-related pretreatment is carried out on the substrate 101 under a high-frequency source power. The high-frequency source power provides sufficiently high energy, for example not less than 800 W. In addition, the ammonia-related pretreatment also provides sufficient ammonia 120, for example the flow rate of ammonia 120 in the ammonia-related pretreatment is not less than 1000 s.c.c.m. Other conditions of the ammonia-related pretreatment may be adjusted optionally. For example, if the super high stress layer 110 is expected to have a compressive stress not greater than −3.5 GPa, the substrate 101 may undergo the ammonia-related pretreatment for not less than 25 seconds.

Besides, if the substrate 101 does not include silicide, or the silicide is not nickel silicide, the reaction temperature for the ammonia-related pretreatment may be greater than 400° C. to pursue a greater compressive stress. Furthermore, during the ammonia-related pretreatment, an auxiliary gas may be used. For example, the auxiliary gas may be N₂, Ar, H₂, silane, or a combination thereof.

Later, as shown in FIG. 2, the super high stress layer 110 is formed on the substrate which has undergone the ammonia-related pretreatment. For example, a PECVD procedure is performed on the substrate 101 which has undergone the ammonia-related pretreatment, to obtain the super high stress layer 110. The super high stress layer 110 may be a nitride-containing layer, for example silicon nitride. Preferably, the ammonia-related pretreatment and the PECVD procedure may be carried in situ in the same chamber.

However, if the substrate 101 includes silicide, for example nickel silicide in particular, the reaction temperature for the ammonia-related pretreatment is recommended not to be greater than 400° C. so as not to damage the silicide. At the meantime, other parameters may be optionally increased, for example, the high-frequency source power, the ammonia flow rate, or the process time, to obtain a stress as low as possible, for example approximately −3.5 GPa stress.

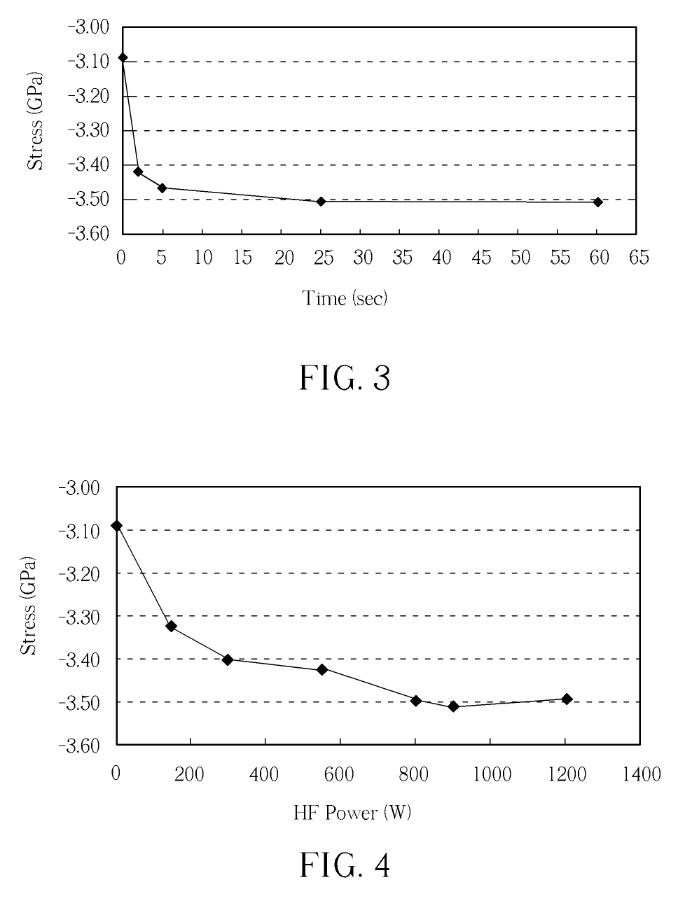

FIG. 3 illustrates a correlation between the pretreatment time and the compression stress in the super high stress layer 110 of the method for forming a super high stress layer of the present invention. It is observed in FIG. 3 that the pretreatment time may be less than 25 seconds if the compression stress may not be less than −3.5 GPa stress, −3.1-3.5 GPa for example. Otherwise, the pretreatment time may be greater than 25 seconds.

FIG. 4 illustrates a correlation between the high-frequency source power and the compression stress in the super high stress layer 110 of the method for forming a super high stress layer of the present invention. It is observed in FIG. 4 that the high-frequency source power may be set to be less than 800 W if the compression stress may not be less than −3.5 GPa stress, −3.1-3.5 GPa for example. Otherwise, the high-frequency source power is set to be not less than 800 W.

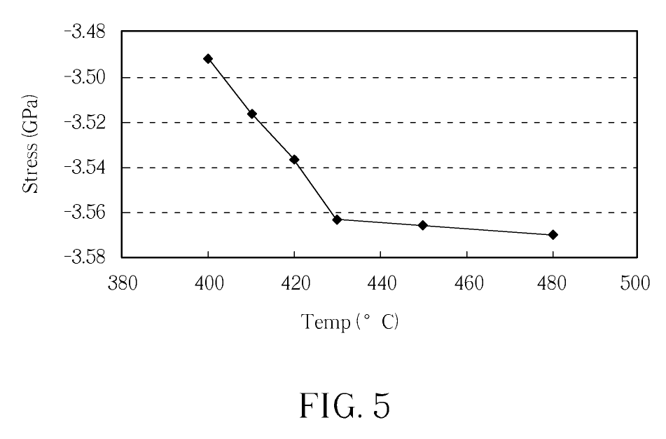

FIG. 5 illustrates a correlation between the reaction temperature and the compression stress in the super high stress layer 110 of the method for forming a super high stress layer of the present invention. It is observed in FIG. 5 that the higher the reaction temperature is, the less the compression stress is. The reaction temperature may be higher than 400° C. if the compression stress is required to be as low as possible. Otherwise, the reaction temperature should not exceed 400° C.

Those skilled in the art will readily observe that numerous modifications and alterations of the device and method may be made while retaining the teachings of the invention.

What is claimed is:

1. A method for forming a super high stress layer, comprising:
providing a substrate;
performing an ammonia-related pretreatment on said substrate under a high-frequency source power, wherein the flow rate of ammonia in said ammonia-related pretreatment is not less than 1000 s.c.c.m. and said high-frequency source power is set to be not less than 800 W; and
forming said super high stress layer on said substrate which has undergone said ammonia-related pretreatment.

2. The method of claim 1, wherein a PVCVD procedure is carried out to obtain said super high stress layer on said substrate which has undergone said ammonia-related pretreatment.

3. The method of claim 1, before said ammonia-related pretreatment further comprising:
performing a silicide procedure on said substrate.

4. The method of claim 1, wherein said super high stress layer has a stress not greater than −3.5 GPa.

5. The method of claim 1, wherein said ammonia-related pretreatment is carried out for not less than 25 seconds.

6. The method of claim 1, wherein said ammonia-related pretreatment is carried out under a temperature not less than 400° C.

7. The method of claim 1, wherein said ammonia-related pretreatment is carried out on said substrate in the presence of an auxiliary gas.

8. The method of claim 7, wherein said auxiliary gas is selected from a group consisting of N₂, Ar, H₂ and silane.

9. The method of claim 1, wherein said super high stress layer has a compression stress.

10. The method of claim 1, wherein said substrate comprises a PMOS.

11. A method for forming a super high stress layer, comprising:
providing a substrate;
performing a silicide procedure on said substrate;
performing an ammonia-related pretreatment on said substrate under a temperature not greater than 400° C. and a under high-frequency source power, wherein the flow rate of ammonia in said ammonia-related pretreatment is not less than 1000 s.c.c.m. and said high-frequency source power is set to be not less than 800 W; and
forming said super high stress layer on said substrate which has undergone said ammonia-related pretreatment.

12. The method of claim 11, wherein said super high stress layer has a compression stress.

13. The method of claim 11, wherein said super high stress layer has a stress less than −3.5 GPa.

14. The method of claim 11, wherein said ammonia-related pretreatment is carried out for not less than 25 seconds.

15. The method of claim 11, wherein said substrate comprises an element with a critical dimension less than 65 Å.

16. The method of claim 11, wherein said ammonia-related pretreatment is carried out on said substrate in the presence of an auxiliary gas.

17. The method of claim 16, wherein said auxiliary gas is selected from a group consisting of N₂, Ar, H₂ and silane.

18. The method of claim 1, wherein said substrate comprises a PMOS.

19. The method of claim 11, wherein said super high stress layer comprises a nitride.

20. The method of claim 1, wherein a PVCVD procedure is carried out to obtain said super high stress layer on said substrate which has undergone said ammonia-related pretreatment.
